(19) United States
(12) Patent Application Publication
(10) Pub. No.: US 2016/0205535 A1
(43) Pub. Date: Jul. 14, 2016

(54) HANDLING OF LOCATION REGISTRATION AT ROAMING

(71) Applicant: Telefonaktiebolaget L M Ericsson (publ), Stockholm (SE)

(72) Inventor: Margarita GLINOU, Athens (GR)

(21) Appl. No.: 14/900,578

(22) PCT Filed: Jul. 2, 2013
(86) PCT No.: PCT/EP2013/063903

§ 371 Date: Dec. 21, 2015

(51) Int. Cl. H04W 8/06

(52) U.S. Cl. CPC H04W 8/06

(57) ABSTRACT

A user equipment is registered in an IMS and in a subscriber database while roaming from the source control node to a target control node in a circuit switched communication network. The method includes receiving a request for updating a location registration of the user equipment from the target control node, where the request comprises a support indication indicating whether the target control node is enabled to register the user equipment into the IMS. The method further includes determining an authorization indication indicating whether the user equipment is to be registered into IMS by the target control node. The method further includes sending a request for cancelling the location registration of the user equipment to the source control node, wherein the request comprises the authorization indication. Therefore the user equipment may be reachable when roaming and load is reduced in the circuit switched communication network.

### TECHNICAL FIELD

The present invention relates to telecommunications and in particular to system, methods, nodes and computer program for cancelling a location registration of a user equipment in a source control node at roaming in a circuit switched communication network.

### BACKGROUND

The concept of 12 reference point and MSC enhanced for ICS (IMS Centralized Services) has been standardized in 3GPP (3rd Generation Partnership Project) technical specification 23.292 V12.1.0 (stage 2) and 24.292 V11.4.0 (stage 3) and allows a mobile subscriber to get services from an IMS (IP Multimedia System) even while being connected via a CS (circuit switched) access of a MSC.

FIG. 1 shows the network architecture of a communication network where a user equipment 100 is roaming in a CS communication network 150. The subscriber using the user equipment 100 has a subscription for ICS and is therefore able to receive services from the IMS 120. The user equipment 100 is registered in the source MSC 110 and now roams out of the coverage area of source MSC 110 into the coverage area of a target MSC 140. Source MSC 110 and target MSC 140 use the HLR subscriber database 130 to obtain subscriber data of the subscriber using the UE 100. The HLR 130 has stored the subscriber record of the subscriber using user equipment 100. In parallel to the registration in the CS communication network 150 the UE 100 is registered in IMS 120. The registration in IMS 120 is initiated and maintained from the MSC 110, 140 where the user equipment 100 is currently registered.

When the UE 100 is now roaming from the source MSC 110 to the target MSC 140, in addition to the change of the MSC registration from the source MSC 110 to the target MSC 140, also the IMS 120 registration is updated. IMS 120 keeps track on in which MSC 110, 140 the equipment 100 is currently registered, for instance in order to deliver terminating sessions to the UE 100 correctly.

FIG. 2 shows a procedure flow of IMS 120 de-registration by source MSC 110 enhanced for ICS when moving to a target MSC 140 enhanced for ICS according to the prior art.

When the UE 100 detects that it has roamed into the area of the target MSC 140, it sends a Location Update message 202 to the target MSC 140. Since the unique subscriber identity of the UE 100 is new in the target MSC 140, the related subscriber data need to be fetched from the subscriber database HLR 130. For this the target MSC 140 sends a message Update Location 204 to the HLR 130. If ICS functionality is supported by the target MSC 140, the target MSC 140 adds to the message an indication that the target MSC 140 supports the ICS functionality.

The HLR 130 receives the Update Location message 204. In the next step the existing registration in the source MSC 110 needs to be removed. The HLR 130 initiates this by sending Cancel Location message 206 to the source MSC 110. After removal of the registration, the source MSC 110 replies with Cancel Location Acknowledgement message 208 to the HLR 130.

More steps and actions have to be performed for completion of the Update Location procedure. For simplicity these are abstracted away and only represented by box 212.

As described above, in addition to the change of the CS registration from the source MSC 110 to the target MSC 140, the IMS 120 registration has to be updated to reflect that the UE 100 is now reachable in the target MSC 140.

So after successful CS registration of the UE 100 in the target MSC 140, the target MSC 140 initiates registration of the UE 100 into the IMS 120 by sending a Register message request 214 to the IMS 120.

For simplicity reasons more details of the IMS registration procedure are abstracted away and are represented by box 216. For the CS access the target MSC 140 enhanced for ICS does not apply the mechanism for multiple simultaneous registrations. This means that any new registration triggered by a target MSC 140 will overwrite the currently existing registration in IMS 120.

When the source MSC 110 receives the message Cancel Location 206 the source MSC 110 has to remove the IMS 120 registration by sending a de-Register message 220 to the IMS 120. In practice this de-Register message 220 is a Register message with a zero expiration value, so immediate expiry.

In prior art the de-registration 220 is initiated from the source MSC 110 with a time delay 218. The time supervision for the delay is started for example when receiving Cancel Location message 206 from the HLR 130. The time delay is applied in order to ensure that the deregistration request from the source MSC 110 arrives at the IMS 120 after the registration request from target MSC 140. The time delay is used in order to reduce signalling inside the IMS 120 when the UE 100 moves between MSCs enhanced for ICS. When a UE 100 is de-registered from IMS 120, registration, subscriber, and state related data is deleted from IMS control nodes. If a new IMS 120 registration follows immediately after, a significant amount of the deleted data has to be rebuilt, which causes additional signalling load inside the IMS 120.

So the registration from the target MSC 140 must be completed before the de-registration from the source MSC 110 is started. Only if the order of the procedures is correct, it can be ensured that the new registration correctly overwrites the existing one and IMS 120 internal signaling is minimized.

For simplicity reasons more details of the IMS de-registration procedure are abstracted away and are represented by box 222.

As described above, the new IMS 120 registration from the target MSC 140 has overwritten the existing IMS 120 registration of the source MSC 110. The IMS keeps track which source node has initiated the registration. The Contact header of the registration request contains the sender's (source MSC 110) IP address or FQDN (Full Qualified Domain Name) in a SIP (Session Initiation Protocol) URI (Uniform Resource Identifier) and the media feature tag “g.3gpp.ics” is set to ‘server’ to indicate that the registration is performed by a MSC node enhanced for ICS.

So when the source MSC 110 tries to de-register the UE 100, IMS 120 detects that the updated registration shall be de-registered by a source node which has not done the latest registration and therefore rejects the de-registration from the source MSC 110 with an Error Response 224. So the de-registration resulting in error responses cause unnecessary signaling and processing load in the CS communication network 150 and in the IMS 120.

The source MSC 110 always performs de-registration 220 with a time delay 218. This results into, in case the target MSC 140 does not perform IMS 120 registration, that the old IMS 120 registration is still maintained for the period of the time delay 218. So the IMS 120 still considers the UE 100 to be reachable in source MSC 110 although the Cancel Location procedure 206, 208 has been completed already. This causes failing terminating sessions during the time delay 218 which is very annoying for the subscriber using the UE 100.

So there is clearly a need to reduce the signaling and processing load in the CS communication network 150 and in the IMS 120 and avoid misrouting and consequently failing of terminating sessions at roaming of a UE 100 between MSC nodes.

### SUMMARY

It is an object of the invention to reduce the network load and enable that the UE 100 is seamlessly reachable when roaming in the circuit switched communication network 150.

The objects defined above are solved by the features of the independent claims. Preferred embodiments of the invention are described in the dependent claims.

According to an exemplary aspect of the invention, a method in a subscriber database for cancelling a location registration of a user equipment in a source control node is provided, wherein the user equipment is registered in a IP Multimedia System (IMS) and in the subscriber database while roaming from the source control node to a target control node, the source and the target control node and the subscriber database are part of a circuit switched communication network. The method comprises receiving a request for updating a location registration of the user equipment from the target control node, wherein the request comprises a support indication indicating whether the target control node is enabled to register the user equipment into the IMS. The method further comprises determining an authorization indication indicating whether the user equipment is to be registered into IMS by the target control node. The method further comprises sending a request for cancelling the location registration of the user equipment to the source control node, wherein the request comprises the authorization indication.

According to another exemplary aspect of the invention, a method in a source control node for cancelling a location registration of a user equipment is provided, wherein the user equipment is registered in a IP Multimedia System (IMS) and in the subscriber database while roaming from the source control node to a target control node, the source and the target control node and the subscriber database are part of a circuit switched communication network. The method comprises receiving a request for cancelling the location registration of the user equipment, wherein the request comprises an authorization indication indicating whether the user equipment is to be registered into IMS by the target control node. The method further comprises preserving the registration of the user equipment in the IMS, if the received authorization indication indicates that the user equipment is to be registered into IMS by the target control node.

According to another exemplary aspect of the invention, a subscriber database for cancelling a location registration of a user equipment in a source control node is provided, wherein the user equipment is registered in a IP Multimedia System (IMS) and in the subscriber database while roaming from the source control node to a target control node, the source and the target control node and the subscriber database are part of a circuit switched communication network. The subscriber database is capable of receiving a request for updating a location registration of the user equipment from the target control node, wherein the request comprises a support indication indicating whether the target control node is enabled to register the user equipment into the IMS. The subscriber database is further capable of determining an authorization indication indicating whether the user equipment is to be registered into IMS by the target control node. The subscriber database is further capable of sending a request for cancelling the location registration of the user equipment to the source control node, wherein the request comprises the authorization indication.

According to another exemplary aspect of the invention, a source control node for cancelling a location registration of a user equipment is provided, wherein the user equipment is registered in a IP Multimedia System (IMS) and in the subscriber database while roaming from the source control node to a target control node, the source and the target control node and the subscriber database are part of a circuit switched communication network. The source control node is capable of receiving a request for cancelling the location registration of the user equipment, wherein the request comprises an authorization indication indicating whether the user equipment is to be registered into IMS by the target control node. The source control node is further capable of preserving the registration of the user equipment in the IMS, if the received authorization indication indicates that the user equipment is to be registered into IMS by the target control node.

According to another exemplary aspect of the invention, a communication system for cancelling a location registration of a user equipment in a source control node is provided, wherein the user equipment is registered in a IP Multimedia System (IMS) and in the subscriber database while roaming from the source control node to a target control node, the source and the target control node and the subscriber database are part of a circuit switched communication network. The communication system comprises a subscriber database and source control node.

The foregoing and other objects, features and advantages of the present invention will become more apparent in the following detailed description of embodiments of the invention illustrated in the accompanying drawings.

### BRIEF DESCRIPTION OF THE DRAWINGS

Further characteristics and advantages of the invention will become better apparent from the detailed description of particular but not exclusive embodiments, illustrated by way of non-limiting examples in the accompanying drawings, wherein:

FIG. 1 is diagram illustrating a system for roaming of an UE in a circuit switched communication network;

FIG. 2 is a procedure flow diagram illustrating a procedure of maintaining an IMS registration while roaming in a circuit switched communication network according to prior art;

FIG. 3 is a procedure flow diagram illustrating a procedure of preserving an IMS registration while roaming in a circuit switched communication network according to the invention;

FIG. 4 is a procedure flow diagram illustrating a procedure of removing an IMS registration while roaming in a circuit switched communication network according to the invention, where the IMS roaming is not authorized by the HLR;

FIG. 5 is a procedure flow diagram illustrating a procedure of removing an IMS registration while roaming in a circuit switched communication network according to the invention, where the IMS roaming is not supported in the target MSC;

FIG. 6 is a flow diagram illustrating a method in a source control node when a UE is roaming in a circuit switched communication network according to the invention;

FIG. 7 is a flow diagram illustrating a method in a subscriber database when a UE is roaming in a circuit switched communication network according to the invention;

FIG. 8 is a block diagram illustrating a control node in a circuit switched communication network according to the invention; and

FIG. 9 is a block diagram illustrating a subscriber database in a circuit switched communication network according to the invention.

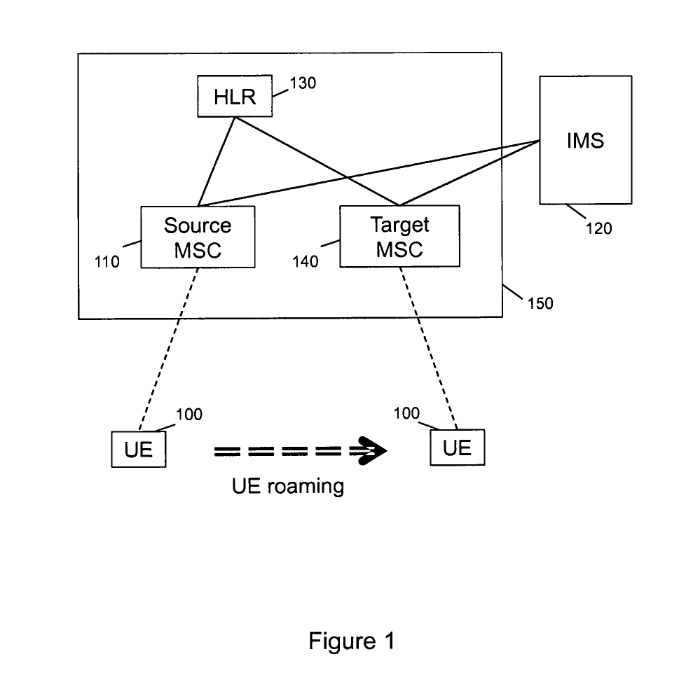

### DETAILED DESCRIPTION

In the following, methods and network nodes for cancelling a location registration of an UE in a source control node and associated computer programs according to the invention are described in more detail.

Within the context of the present application, the term “communication network” may particularly denote a collection of nodes or entities, related transport links, and associated management needed for running a service, for example a telephony service or a packet transport service. Depending on the service, different node types or entities may be utilized to realize the service. A network operator owns the communication network and offers the implemented services to its subscribers. Typical examples of a communication network are radio access network (such as GSM, 3G, WCDMA, CDMA, LTE, 802.11), mobile backhaul network, or core network (such as IMS, CS, Packet Core).

Within the context of the present application, the term “control node” refers to a node of the communication network primarily performing control procedures for sessions or calls and services of a subscriber of the communication network. The term typically refers to those entities of the communication network handling control plane, subscriber data, services, or signaling traffic associated with user traffic in the communication network. In a core network a control node may be a MSC, Mobility Management Entity (MME), P-CSCF, S-CSCF, or TAS nodes.

Within the context of the present application, the term “user equipment” (UE) refers to a device for instance used by a person for his or her personal communication. It can be a telephone type of device, for example a fixed telephone or a SIP phone, cellular telephone, a mobile station, cordless phone, or a personal digital assistant type of device like laptop, notebook, notepad equipped with a wireless data connection. The UE may also be associated with non-humans like animals, plants, or even machines. A UE may be equipped with a SIM (Subscriber Identity Module) comprising unique identities such as IMSI (International Mobile Subscriber Identity) and/or TMSI (Temporary Mobile Subscriber Identity) associated with a subscriber using the UE. The presence of a SIM within a UE customizes the UE uniquely with a subscription of the subscriber.

Within the context of the present application, the term “subscriber database” refers to a database run by the network operator to store the information related to the subscribers of a network run by the operator. A subscriber database can be for example a Home Location Register, HLR, or a Visited Location Register, VLR, or a Home Subscriber Server, HSS, or a combination of HLR and HSS. A subscriber database may also be internally structured into a front end part handling the signaling with the other network nodes of the communication network and a generic database for storage of the data according to data layered architecture principles.

Within the context of the present application, the term “roaming” refers to a movement of a UE within a communication network. In order to receive services, the UE is registered in a control node being responsible for the geographical area where the UE is currently located. While moving, the UE may leave the responsibility area of the first control node, the so called source control node, and enter the responsibility area of a second control node, he so called target control node. If this movement happens while the UE is engaged in a call, this movement is denoted as handover, because the ongoing call is handed over from the source control node to the target control node. If this movement happens while the UE has no call ongoing, this movement is denoted as roaming. In this case the registration of the UE into the control node has to be shifted over from the source control node to the target control node. In a circuit switched communication network the control nodes are typically MSC nodes.

Within the context of the present application, the term “MSC” refers to a control node of the circuit switched communication network. The MSC may be combined with a VLR and be therefore also called MSCNLR. The MSC node may also be enabled to control a remote MGW (Media Gateway) and therefore act as a server and may therefore be also called MSC Server or short MSC-S. Within the context of the present application MSC, MSCNLR and MSC-S are functional equivalent.

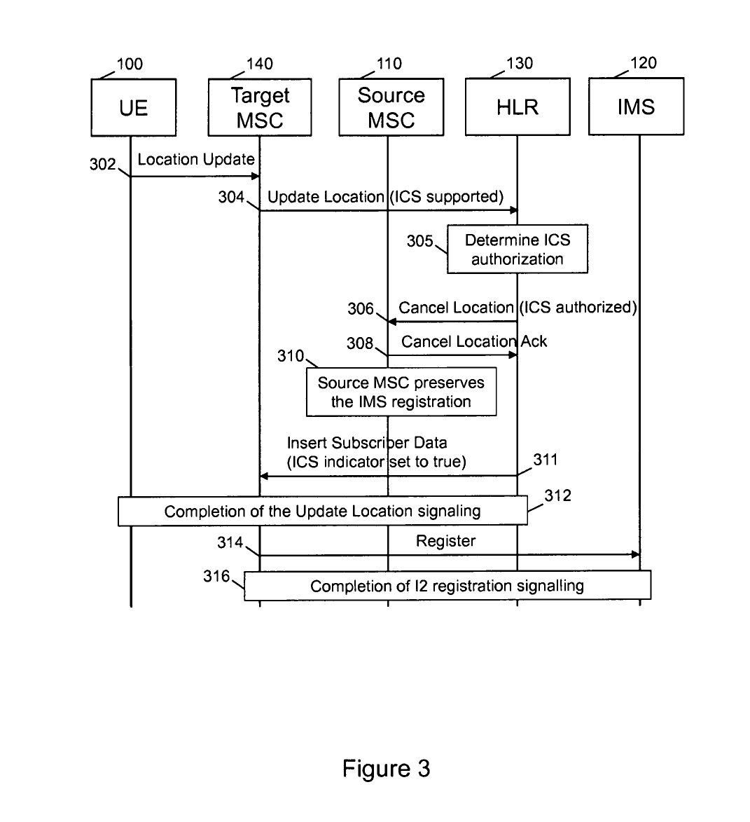

Referring now to FIG. 3, this figure shows a procedure flow diagram illustrating a procedure while roaming in a circuit switched communication network 150 according to an embodiment.

The figure shows a method in a HLR 130 for cancelling a location registration of a UE 100 in a source MSC 110, wherein the UE 100 is registered in an IMS 120 and in the HLR 130 while roaming from the source MSC 110 to a target MSC 140, the source MSC 110 and the target MSC 140 and the HLR 130 are part of a circuit switched communication network 150. So here the source MSC 110 corresponds to the source control node and the target MSC 140 corresponds to the target control node. The HLR 130 corresponds to the subscriber database. For simplification reasons the internal handling within the IMS 120 network are omitted and only the interaction towards and from the IMS 120 network are shown.

The procedure flow is triggered by the UE 100 roaming into the coverage area of the target MSC 140. When the UE determines this, the UE 100 sends a Location Update message 302 to the target MSC 140. The Location Update request message 302 may be a corresponding protocol message as defined on the A-interface or lu-interface between a MSC and a UE across a radio access network. The protocol may correspond to DTAP (Direct Transfer Application Part) or RANAP (Radio Access Network Application Part). The Location Update request message 302 may also correspond to a BSSAP+ (Base Station Subsystem Application Part +) protocol on a Gs-interface between a MSC and a SGSN, when combined circuit switched- and packet switched- location update procedures are used.

The target MSC 140 receives the Location Update message 302 from the UE 100. Since the unique subscriber identity of the UE 100 is not known in the target MSC 140, the HLR 130 needs to be informed about the roaming event and related subscriber data have to be fetched from the HLR 130. So the procedure flow is continued by the target MSC 140 sending a request 304 for Update Location registration of the UE 100 to the HLR 130. The request 304 comprises a support indication indicating whether the target MSC 140 is enabled to register the UE 100 into the IMS 120. The capability of registering a UE into the IMS corresponds to support of ICS functionality. So if the target MSC 140 indicates the support of ICS, this means that the target MSC 140 is enabled to register the UE 100 into the IMS 120. The request 304 for Update Location registration may be a corresponding MAP (Mobile Application Part) protocol message.

The HLR 130 receives the request 304 for Update Location registration, the request comprising a support indication indicating whether the target MSC 140 is enabled to register the UE 100 into the IMS 120. In the next step the HLR 130 determines 305 an authorization indication indicating whether the UE 100 is to be registered into IMS 120 by the target MSC 140. This authorization indication is set to “ICS authorized” if a support indication has been received from the target MSC 140. The HLR 130 may in addition to this also take into account other conditions. For example the HLR 130 may consider subscriber data related to the UE 100. If the current subscriber data indicates that the subscriber using the UE 100 has no subscription to the ICS service, then the authorization indication may be set to “ICS not authorized”. The HLR 130 may consider configuration data configured by a network operator of the circuit switched communication network 150. The network operator may have configured the HLR 130 to not apply ICS functionality. The HLR 130 may consider the geographical area served by the target MSC 140. So the ICS functionality may not to be supported in the geographical area served by the target MSC 140, wherein the area served by the target MSC 140 may be associated with an identifier of the target MSC 140. The HLR 130 may take into account also combinations of the additional conditions to determine the authorization indication.

After having determined the authorization indication, the HLR 130 sends a request 306 for cancelling the location registration of the UE 100 to the source MSC 110, wherein the request comprises the authorization indication. The Cancel Location message 306 may correspond to a MAP protocol message.

The source MSC 110 receives the request 306 for cancelling the location registration of the UE 100 and acknowledges it by returning a Cancel Location Acknowledgment message 308 to the HLR 130. The Cancel Location Acknowledgment message 308 may correspond to a MAP protocol message.

The HLR 130 receives the Cancel Location Acknowledgment message 308.

In the next step the source MSC 110 analyzes the authorization indication received in the Cancel Location message 306. In this procedure flow of FIG. 3 the authorization indication indicates “ICS authorized”, corresponding to that the target MSC 140 is enabled to register the UE 100 into the IMS 120. The source MSC 110 then preserves the registration of the UE 100 in the IMS 120, if the received authorization indication indicates that the UE 100 is to be registered into IMS 120 by the target MSC 140. By omitting the de-registration procedure, signaling and processing resources are saved in the circuit switched communication network 150 and in the IMS.

Based on the determined authorization indication the HLR 130 sets an ICS indicator in the Insert Subscriber Data message 311 downloading the subscriber data to the target MSC 140. If the authorization indication indicates that the UE 100 is to be registered into IMS 120 by the target MSC 140, the ICS indicator in the Insert Subscriber Data message 311 is set to “true” by the HLR 130. Otherwise the ICS indicator in the Insert Subscriber Data message 311 is set to “false”. The Insert Subscriber Data message 311 may correspond to a MAP protocol message.

The target MSC 140 receives the Insert Subscriber Data message 311 comprising the subscriber data and the ICS indicator.

More steps and actions have to be performed by the UE 100, the target MSC 140, and the HLR 130 for completion of the Update Location procedure. For simplicity these are abstracted away and only represented by box 312.

After completion of the Update Location procedure 312, in addition to the change of the CS registration from the source MSC 110 to the target MSC 140, the IMS 120 registration has to be updated to reflect that the UE 100 is now reachable in the target MSC 140. So the target MSC 140 analyses the received ICS indicator and if it is set to “true”, the target MSC 140 initiates registration of the UE 100 into the IMS 120 by sending a Register message request 314 to the IMS 120. This Register message request 314 may correspond to SIP protocol message.

The IMS 120 receives the Register message request 314.

For simplicity reasons more details of the IMS 120 registration procedure are abstracted away and are represented by box 316. For a CS access the target MSC 140 does not apply the mechanism for multiple simultaneous registrations in IMS 120. This means that this new registration 314 overwrites the currently existing registration in IMS 120.

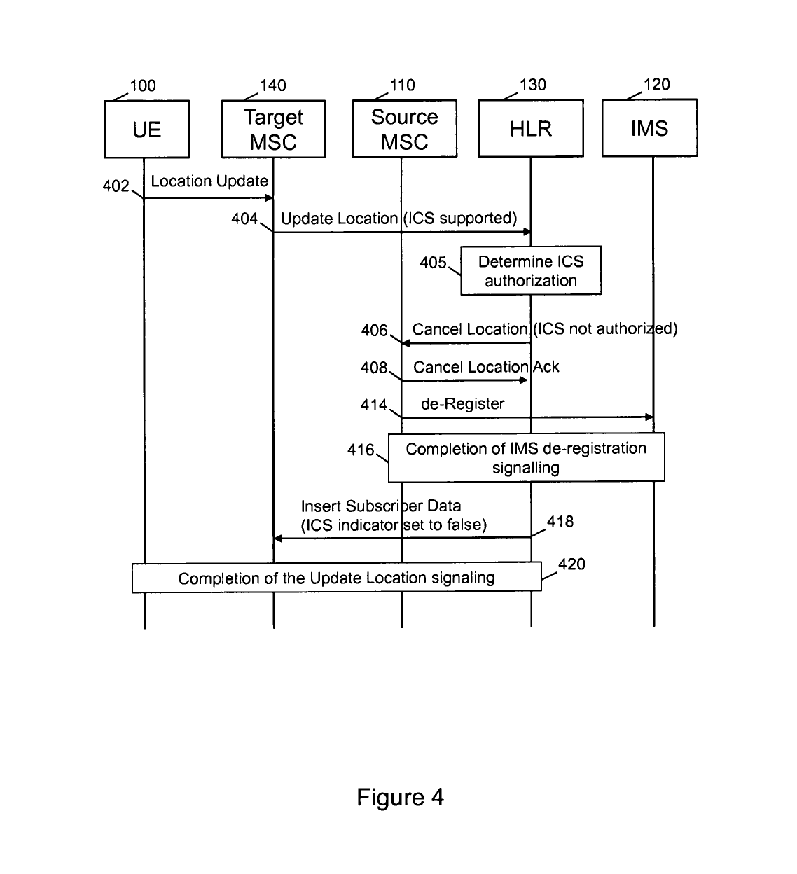

Referring now to FIG. 4, this figure shows a procedure flow diagram illustrating a procedure of removing an IMS 120 registration while roaming in a circuit switched communication network 150, where the IMS 120 roaming is not authorized by the HLR 130, according to an embodiment.

The procedure flow is triggered by the UE 100 roaming into the coverage area of the target MSC 140. When the UE determines this, the UE 100 sends a Location Update message 402 to the target MSC 140.

The target MSC 140 receives the Location Update message 402 from the UE 100. Since the unique subscriber identity of the UE 100 is not known in the target MSC 140, the HLR 130 needs to be informed about the roaming event and subscriber data has to be fetched from the HLR 130. So the procedure flow is continued by the target MSC 140 sending a request 404 for Update Location registration of the UE 100 to the HLR 130. The request 304 comprises a ICS support indication indicating whether the target MSC 140 is enabled to register the UE 100 into the IMS 120.

The HLR 130 receives the request 404 for Update Location registration, the request comprising a support indication indicating whether the target MSC 140 is enabled to register the UE 100 into the IMS 120. In the next step the HLR 130 determines 405 an authorization indication indicating whether the UE 100 is to be registered into IMS 120 by the target MSC 140. This determination step is the same as described in 305 for FIG. 3. However, in this procedure flow of FIG. 4 the result is that the authorization indication indicates “ICS not authorized”.

After having determined the authorization indication, the HLR 130 sends a request 406 for cancelling the location registration of the UE 100 to the source MSC 110, wherein the request comprises the authorization indication.

The source MSC 110 receives the request 406 for cancelling the location registration of the UE 100 and acknowledges it by returning a Cancel Location Acknowledgment message 408 to the HLR 130.

The HLR 130 receives the Cancel Location Acknowledgment message 408.

In the next step the source MSC 110 analyzes the authorization indication received in the Cancel Location message 406. In this procedure flow of FIG. 4 the authorization indication indicates “ICS not authorized”. The source MSC 110 de-registers the UE 100 from the IMS 120, if the received authorization indication indicates that the UE 100 is not to be registered into IMS 120 by the target MSC 140. So the source MSC 110 sends a de-Register message request 414 to the IMS 120. This de-Register message request 414 may correspond to SIP protocol message Register wherein an expiration value within the SIP Register message is set to zero.

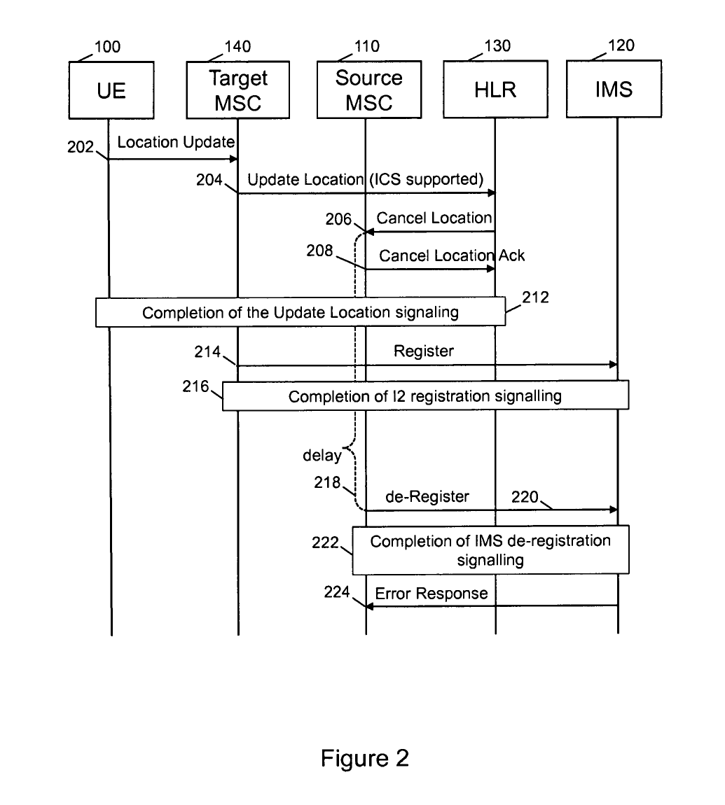

This de-Register message request 414 is sent by the source MSC 110 immediately after reception of the request 406 for cancelling the location registration of the UE 100, meaning that no time delay is applied to delay the sending of the de-Register message request 414. In particular, no time delay 218 as shown in FIG. 2 of the prior art procedure is applied by the source MSC 110.

The IMS 120 receives the de-Register message request 414.

For simplicity reasons more details of the IMS 120 de-registration procedure are abstracted away and are represented by box 416.

As next step of the Update Location procedure the HLR 130 downloads the subscriber data of the subscriber using the UE 100 to the target MSC 140. This is done by the HLR 130 sending Insert Subscriber Data message 418 to the target MSC 140. The Insert Subscriber Data message 418 may correspond to a MAP protocol message. If the HLR 130 has determined the authorization indication to indicate “ICS not authorized”, the HLR 130 also adapts the subscriber data sent to the target MSC 140 to contain a flag indicating that ICS functionality shall not be applied for the UE 100, so setting the ICS indicator to “false”.

When the target MSC 140 receives the Insert Subscriber Data message 418 for the UE 100 comprising an indication that ICS functionality shall not be applied for the UE 100, the target MSC 140 does not register the UE 100 into IMS 120. The consequence is that the de-register message 414 removes the registration in IMS 120 and the UE 100 is no longer registered in IMS 120.

More steps and actions have to be performed by the UE 100, the target MSC 140, and the HLR 130 for completion of the Update Location procedure. For simplicity these are abstracted away and only represented by box 420.

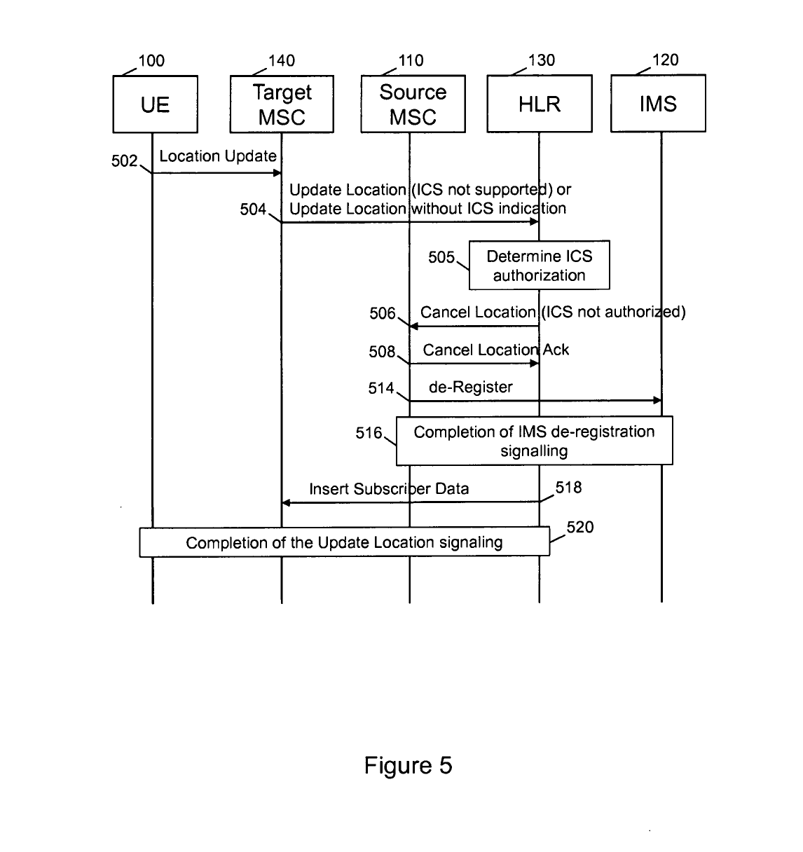

Referring now to FIG. 5, this figure shows a procedure flow diagram illustrating a procedure of removing an IMS 120 registration while roaming in a circuit switched communication network 150, where the IMS roaming is not supported in the target MSC, according to an embodiment.

The procedure flow is triggered by the UE 100 roaming into the coverage area of the target MSC 140. When the UE determines this, the UE 100 sends a Location Update message 502 to the target MSC 140.

The target MSC 140 receives the Location Update message 502 from the UE 100. Since the unique subscriber identity of the UE 100 is not known in the target MSC 140, the HLR 130 needs to be informed about the roaming event and subscriber data has to be fetched from the HLR 130. So the procedure flow is continued by the target MSC 140 sending a request 504 for Update Location registration of the UE 100 to the HLR 130. Since in this procedure flow of FIG. 5 it is assumed that the target MSC 140 does not support the ICS functionality, the Location Update message 502 would not contain any ICS support indication, or the ICS support indication is included but indicates that ICS is not supported. The target MSC 140 may also support ICS functionality in general but the target MSC 140 may be configured that for roaming subscribers of a certain other network the ICS functionality shall not be applied due to roaming agreements between the two network operators. In this scenario the target MSC 140 may include the CS support indication but indicate that ICS is not supported. So in this case the target MSC 140 is not configured for registering the UE 100 into the IMS 120.

The HLR 130 receives the request 504 for Update Location registration, the request may comprise a support indication indicating that the target MSC 140 is not enabled to register the UE 100 into the IMS 120, or no ICS support indication. In the next step the HLR 130 determines 505 an authorization indication indicating whether the UE 100 is to be registered into IMS 120 by the target MSC 140. This determination step is the same as described in 305 for FIG. 3. However, in this procedure flow of FIG. 5 the result is that the authorization indication indicates “ICS not authorized”, as the target MSC 140 does not support the ICS functionality.

After having determined the authorization indication, the HLR 130 sends a request 506 for cancelling the location registration of the UE 100 to the source MSC 110, wherein the request comprises the authorization indication.

The source MSC 110 receives the request 506 for cancelling the location registration of the UE 100 and acknowledges it by returning a Cancel Location Acknowledgment message 508 to the HLR 130.

The HLR 130 receives the Cancel Location Acknowledgment message 508.

In the next step the source MSC 110 analyzes the authorization indication received in the Cancel Location message 506. In this procedure flow of FIG. 5 the authorization indication indicates “ICS not authorized”. The source MSC 110 de-registers the UE 100 from the IMS 120, if the received authorization indication indicates that the UE 100 is not to be registered into IMS 120 by the target MSC 140. So the source MSC 110 sends a de-Register message request 514 to the IMS 120.

This de-Register message request 514 is sent by the source MSC 110 immediately after reception of the request for cancelling the location registration of the UE 100, so a time delay 218 as shown in FIG. 2 of the prior art procedure is not applied by the source MSC 110.

The IMS 120 receives the de-Register message request 514.

For simplicity reasons more details of the IMS 120 de-registration procedure are abstracted away and are represented by box 516.

As next step of the Update Location procedure the HLR 130 downloads the subscriber data of the subscriber using the UE 100 to the target MSC 140. This is done by the HLR 130 sending Insert Subscriber Data message 518 to the target MSC 140. In this case the Insert Subscriber Data message 518 may contain no ICS indicator, or an ICS indicator set to “false”. If the target MSC 140 indicated in request 504 for Update Location registration that it supports ICS functionality, the HLR 130 adds the ICS indicator to the Insert Subscriber Data message 518. If the target MSC 140 has not indicated in request 504 for Update Location registration that it supports ICS functionality, the HLR 130 assumes that that target MSC 140 does not support the ICS functionality. In that case the HLR 130 may omit to include any indication related to the ICS functionality in the Insert Subscriber Data message 518, or the HLR 130 may still add the ICS indicator as it would anyway be ignored by the target MSC 140.

When the target MSC 140 receives the Insert Subscriber Data message 518 for the UE 100 comprising an indication that ICS functionality shall not be applied for the UE 100, the target MSC 140 does not register the UE 100 into IMS 120. The consequence is that the de-register message 514 removes the registration in IMS 120 and the UE 100 is no longer registered in IMS 120. In the case that the target MSC 140 does not support the ICS functionality, the target MSC 140 ignores any received indication related to the ICS functionality.

More steps and actions have to be performed by the UE 100, the target MSC 140, and the HLR 130 for completion of the Update Location procedure. For simplicity these are abstracted away and only represented by box 520.

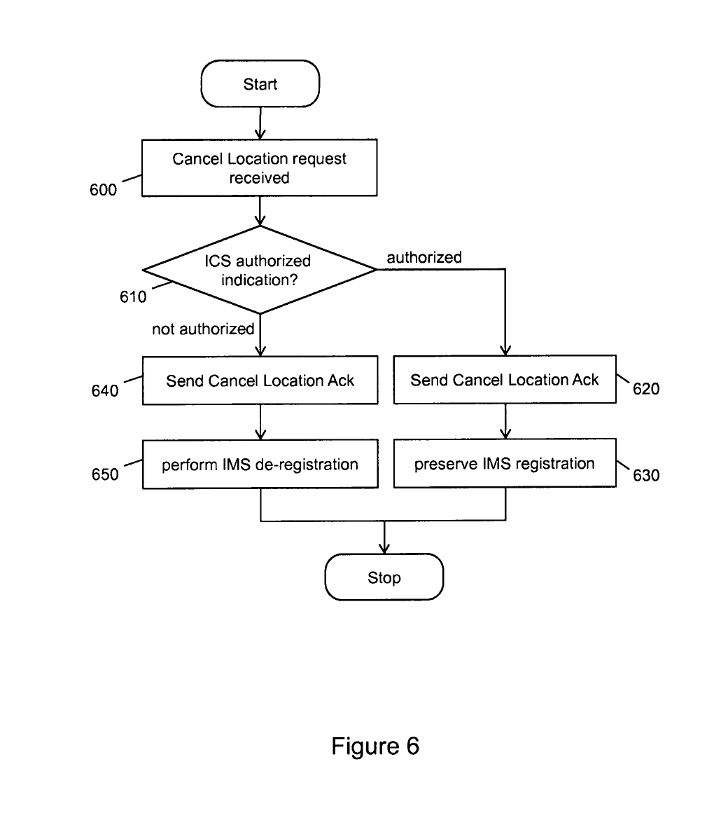

Referring now to FIG. 6, this figure shows a flow diagram illustrating a method in a source control node when a UE is roaming in a circuit switched communication network 150 according to an embodiment. The source control node may correspond to a source MSC 110 of FIGS. 3 to 5.

In step 600 the source MSC 110 receives a Cancel Location request. This message may correspond to a Cancel Location request 306, 406, 506 from a HLR 130. The Cancel Location message may correspond to a MAP protocol message.

In step 610 the source MSC 110 analyzes the received Cancel Location request for the ICS authorization indication. If the ICS authorization indication is received and it indicates “authorized”, the UE 100 is to be registered into IMS 120 by the target MSC 140.

In step 620 the source MSC 110 sends a Cancel Location Acknowledgment message. The Cancel Location Acknowledgment message may correspond to a MAP protocol message and may further correspond to a Cancel Location Acknowledgment 308, 408, 508 to the HLR 130.

Since the UE 100 is to be registered into IMS 120 by the target MSC 140, the source MSC 110 preserves in step 630 the IMS registration and the flow ends.

By preserving the IMS registration in step 630 the source MSC 110 enables the IMS 120 registration to be overwritten by the IMS 120 registration initiated by the target MSC 140.

If in step 610 the ICS authorization indication is received and it indicates “not authorized”, the UE 100 is to not be registered into IMS 120 by the target MSC 140.

In step 640 the source MSC 110 sends a Cancel Location Acknowledgment message. The Cancel Location Acknowledgment message may correspond to a MAP protocol message and may further correspond to a Cancel Location Acknowledgment message 308, 408, 508 to the HLR 130.

Since the UE 100 is to not be registered into IMS 120 by the target MSC 140, the source MSC 110 initiates in step 650 the de-registration of the UE 100 from IMS 120 by sending a de-register message. The de-register message request may correspond to SIP protocol message Register 414 or 514 wherein an expiration value within the SIP Register message is set to zero. After that step the flow ends.

Since the UE 100 shall not receive ICS functionality in the target MSC 140, the IMS 120 registration is deleted and therefore the UE 100 cannot initiate or receive any IMS 120 related calls over the 12 interface. This IMS de-registration is triggered immediately by the source MSC 110, so a time delay 218 as shown in FIG. 2 of the prior art procedure is not applied by the source MSC 110.

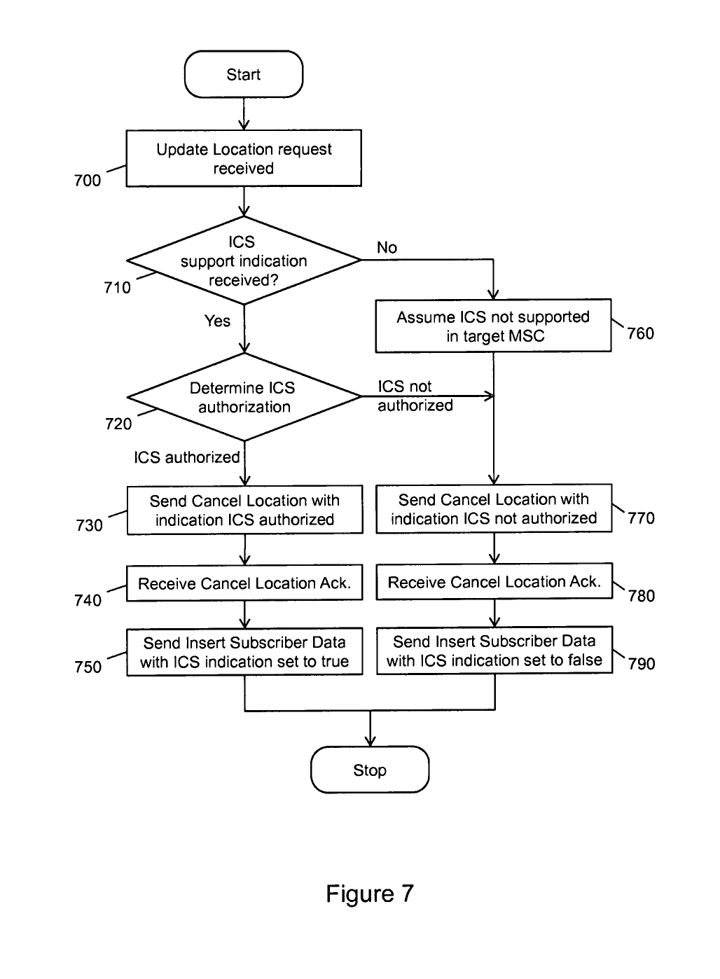

Referring now to FIG. 7, this figure shows a flow diagram illustrating a method in a subscriber database when a UE is roaming in a circuit switched communication network 150 according to an embodiment. The subscriber database may correspond to a HLR 130 of FIGS. 3 to 5.

In step 700 the HLR 130 receives an Update Location request. The Update Location message may correspond to a MAP protocol message and may further correspond to an Update Location 304, 404, 504 from a target MSC 140.

The HLR 130 analyzes in step 710 the received Update Location message whether an ICS support indication has been received from the target MSC 140. If no ICS support indication has been received from the target MSC 140, the HLR 130 assumes in step 760 that the target MSC 140 does not support any ICS functionality. If an ICS support indication has been received from the target MSC 140, the flow continues with step 720.

In step 720 the HLR 130 determines the ICS authorization indication indicating whether the UE 100 is to be registered into IMS 120 by the target MSC 140. This authorization indication is set to “ICS authorized” if a support indication has been received from the target MSC 140. The HLR 130 may in addition to this also take into account other conditions. For example the HLR 130 may consider subscriber data related to the UE 100. If the current subscriber data indicates that the subscriber using the UE 100 has no subscription to the ICS service, then the authorization indication may be set to “ICS not authorized”. The HLR 130 may consider configuration data configured by a network operator of the circuit switched communication network 150. The network operator may have configured the HLR 130 to not apply ICS functionality. The HLR 130 may consider the geographical area served by the target MSC 140. So the ICS functionality may not to be supported in the geographical area served by the target MSC 140, wherein the area served by the target MSC 140 may be associated with an identifier of the target MSC 140. The HLR 130 may take into account also combinations of the additional conditions to determine the authorization indication.

If the authorization indication is set to “ICS authorized” the flow continues with step 730. In this step the HLR 130 sends the Cancel Location message. This message may correspond to a Cancel Location request 306, 406, 506 sent from the HLR 130 to the source MSC 110. The Cancel Location message may correspond to a MAP protocol message. The Cancel Location message comprises the determined authorization indication set to “ICS authorized”.

In step 740 the HLR 130 receives the Cancel Location Acknowledgment message. The Cancel Location Acknowledgment message may correspond to a MAP protocol message and may further correspond to a Cancel Location Acknowledgment message 308, 408, 508 sent from the source MSC 110 to the HLR 130.

In step 750 the HLR sends the Insert Subscriber Data message. The Insert Subscriber Data message may correspond to a MAP protocol message and may further correspond to an Insert Subscriber Data message sent from the HLR 130 to the target MSC 140. Based on the determined authorization indication the HLR 130 sets an ICS indicator in the Insert Subscriber Data message downloading the subscriber data to the target MSC 140. If the authorization indication indicates that the UE 100 is to be registered into IMS 120 by the target MSC 140, the ICS indicator in the Insert Subscriber Data message is set to “true” by the HLR 130.

If the determination of the authorization indication in step 720 resulted in that the authorization indication is set to “ICS not authorized” the flow continues with step 770. In this step the HLR 130 sends the Cancel Location message. This message may correspond to a Cancel Location request 306, 406, 506 sent from the HLR 130 to the source MSC 110. The Cancel Location message may correspond to a MAP protocol message. The Cancel Location message comprises the determined authorization indication set to “ICS not authorized”.

In step 780 the HLR 130 receives the Cancel Location Acknowledgment message. The Cancel Location Acknowledgment message may correspond to a MAP protocol message and may further correspond to a Cancel Location Acknowledgment message 308, 408, 508 sent from the source MSC 110 to the HLR 130.

In step 790 the HLR sends the Insert Subscriber Data message. The Insert Subscriber Data message may correspond to a MAP protocol message and may further correspond to an Insert Subscriber Data message sent from the HLR 130 to the target MSC 140. Based on the determined authorization indication the HLR 130 sets an ICS indicator in the Insert Subscriber Data message downloading the subscriber data to the target MSC 140. If the authorization indication indicates that the UE 100 is not to be registered into IMS 120 by the target MSC 140, the ICS indicator in the Insert Subscriber Data message is set to “false” by the HLR 130.

After step 750, or after step 790 the flow ends.

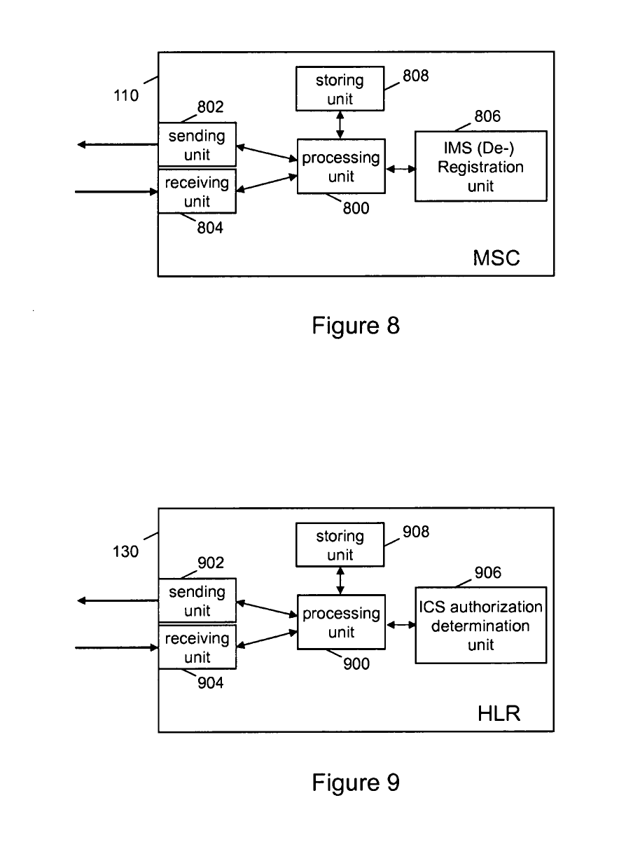

Referring now to FIG. 8, this figure shows a block diagram illustrating a source control node in a circuit switched communication network according to an embodiment. The illustrated entity may correspond to the source MSC 110. The source control node 110 may be adapted to perform one or more steps of the above described method shown in FIG. 6.

The source control node 110 may comprise a number of functional units, which are described in further detail below and which are adapted to perform respective method steps.

A processing unit 800 of the source control node 110 may be adapted to receive a request for cancelling the location registration of a UE 100, wherein the request comprises an authorization indication indicating whether the UE 100 is to be registered into IMS 120 by the target control node 140. The processing unit 800 may further be adapted to preserve the registration of the UE 100 in the IMS 120, if the received authorization indication indicates that the UE 100 is to be registered into IMS 120 by the target control node 140. In a practical implementation the processing unit 800 may be one processor taking care of all the above functions, or may also be distributed over more than one processor, wherein the functions are distributed over the available processors.

The source control node 110 further comprises a sending unit 802 and a receiving unit 804 via which the source control node 110 can communicate with a subscriber database 130, or with other entities of the communication network 150 or the IMS 120. The sending unit 802 may send out signaling messages composed by the processing unit 800. The receiving unit 804 may receive signaling messages originating from a subscriber database 130, or from other entities of the communication network 150, or from IMS 120, and forward the received signaling messages to the processing unit 800 for handling.

The source control node 110 may also comprise a storing unit 808 for storing information related to the handling of UEs and related subscriber data. The storing unit 808 may comprise various types of memory such as volatile memory, non-volatile memory, hard disk drives, solid state drives, a network interface to a database or a data center, secure digital cards, or hardware such as smart cards, non-reversible chips, security chips, security modules, or trusted platform module devices. The storing unit 808 may be used by the processing unit 800 to store information, for example subscriber data or program code.

The source control node 110 may also comprise an IMS (De-)Registration functional unit 806. The IMS (De-)Registration functional unit 806 may be adapted to perform the functions of de-registering a UE 100 from the IMS 120 when for example ICS roaming is not authorized in the geographical area of the target control node 140. Unit 806 may also perform a related initial registration and re-registration of a UE 100 from the IMS 120. The IMS (De-)Registration functional unit 806 interacts with the processing unit 800 for processing of protocol messages and with the sending unit 802 and the receiving unit 804 for sending and receiving of corresponding protocol messages.

Referring now to FIG. 9, this figure shows a block diagram illustrating a subscriber database in a circuit switched communication network according to an embodiment. The illustrated entity may correspond to the HLR 130. The subscriber database 130 may be adapted to perform one or more steps of the above described method shown in FIG. 7.

The subscriber database 130 may comprise a number of functional units, which are described in further detail below and which are adapted to perform respective method steps.

A processing unit 900 of the subscriber database 130 may be adapted to receive a request for updating a location registration of the UE 100 from the target control node 140, wherein the request comprises a support indication indicating whether the target control node 140 is enabled to register the UE 100 into the IMS 120. The processing unit 900 may further be adapted to determine an authorization indication indicating whether the UE 100 is to be registered into IMS 120 by the target control node 140. The processing unit 900 may further be adapted to send a request for cancelling the location registration of the UE 100 to the source control node 110, wherein the request comprises the authorization indication. The processing unit 900 may further be adapted to send subscriber data for the subscriber using the UE 100 to the target control node 140, wherein the subscriber data comprises an indication whether the UE 100 is to be registered into IMS 120 by the target control node 140. In a practical implementation the processing unit 900 may be one processor taking care of all the above functions, or may also be distributed over more than one processor, wherein the functions are distributed over the available processors.

The subscriber database 130 further comprises a sending unit 902 and a receiving unit 904 via which the subscriber database 130 can communicate with source control node 110 or a target control node 140, or with other entities of the communication network 150. The sending unit 902 may send out signaling messages composed by the processing unit 900. The receiving unit 904 may receive signaling messages originating from a source control node 110 or a target control node 140 or from other entities of the communication network 150, and forward the received signaling messages to the processing unit 900 for handling.

The subscriber database 130 may also comprise a storing unit 908 for storing information related to the handling of UEs and related subscriber data. The storing unit 908 may comprise various types of memory such as volatile memory, non-volatile memory, hard disk drives, solid state drives, a network interface to a database or a data center, secure digital cards, or hardware such as smart cards, non-reversible chips, security chips, security modules, or trusted platform module devices. The storing unit 908 may be used by the processing unit 900 to store information, for example subscriber data or program code.

The subscriber database 130 may also comprise an ICS authorization determination unit 906. The ICS authorization determination unit 906 may be adapted to perform the functions of determining the ICS authorization indication. The ICS authorization determination unit 906 determines the ICS authorization indication indicating whether the UE 100 is to be registered into IMS 120 by the target control node 140. This authorization indication is set to “ICS authorized” if a support indication has been received from the target control node 140. The ICS authorization determination unit 906 may in addition to this also take into account other conditions. For example the ICS authorization determination unit 906 may consider subscriber data related to the UE 100. If the current subscriber data indicates that the subscriber using the UE 100 has no subscription to the ICS service, then the authorization indication may be set to “ICS not authorized”. The ICS authorization determination unit 906 may consider configuration data configured by a network operator of the circuit switched communication network 150. The network operator may have configured the ICS authorization determination unit 906 to not apply ICS functionality. The ICS authorization determination unit 906 may consider the geographical area served by the target control node 140. So the ICS functionality may not to be supported in the geographical area served by the target control node 140, wherein the area served by the target control node 140 may be associated with an identifier of the target control node 140. The ICS authorization determination unit 906 may take into account also combinations of the additional conditions to determine the authorization indication. The IMS De-Registration functional unit 906 interacts with the processing unit 900 for processing of protocol messages and with the sending unit 902 and the receiving unit 904 for sending and receiving of corresponding protocol messages.

According to another embodiment, a set of instructions is provided. The set of instructions may be executed by the processing units 800, 900 of the above mentioned source control node 110 and subscriber database 130 such that a method for cancelling a location registration of a UE 100 in a source control node 110 as described above with reference to FIGS. 6 and 7 may be carried out or be controlled. In particular, the source control node 110 and subscriber database 130 may be caused to operate in accordance with the above described method by executing the set of instructions.

The set of instructions may be embodied as executable processor code, for example a set of instructions product. The processor code may also be derivable from the set of instructions by compilation of the set of instructions.

A carrier may transport the set of instructions, wherein the carrier may be a signal of radio, optical, or electrical nature. By alternative, the carrier may be a disk or tape of magnetic or optical nature, a memory device, or simply paper.

The carrier may also be a computer readable medium, for example the storing unit 808, 908 of the source control node 110 and subscriber database 130, or the set of instructions may be configured as downloadable information.

According to another embodiment, a computer program, which, when being executed by at least one processor, is adapted to carry out or control a method for routing of sessions to other communication networks according to any one of claims 1 to 10.

One or more embodiments as described above may enable at least one of the following technical effects:
Saving of processing capacity in the source MSC 110 and in the IMS 120 since de-registrations are omitted which would anyway end up in an error response 224.
Saving of signaling capacity in the circuit switched communication network 150 and in the IMS 120 as de-registrations are omitted which would anyway end up in an error response 224.
De-registrations are immediately triggered by the source MSC 110. In the prior art the source MSC 110 always performs de-registration 220 with a time delay 218. This results into, in case the target MSC 140 does not perform IMS 120 registration, that the old IMS 120 registration is still maintained for the period of the time delay 218. So the IMS 120 still considers the UE 100 to be reachable in source MSC 110 although the Cancel Location procedure 206, 208 has been completed already. This causes failing terminating sessions during the time delay 218 which is very annoying for the subscriber using the UE 100. This is eliminated by the immediate de-registration by the source MSC 110.

Modifications and other embodiments of the disclosed invention will come to mind to one skilled in the art having the benefit of the teachings presented in the foregoing descriptions and the associated drawings. Therefore, it is to be understood that the embodiments are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method in a subscriber database for cancelling a location registration of a user equipment in a source control node, wherein the user equipment is registered in a IP Multimedia System (IMS) and in the subscriber database while roaming from the source control node to a target control node, the source and the target control node and the subscriber database being part of a circuit switched communication network, the method comprising:
receiving a request for updating a location registration of the user equipment from the target control node, wherein the request comprises a support indication indicating whether the target control node is enabled to register the user equipment into the IMS;
determining an authorization indication indicating whether the user equipment is to be registered into IMS by the target control node; and
sending a request for cancelling the location registration of the user equipment to the source control node, wherein the request comprises the authorization indication.

2. The method according to claim 1, wherein the subscriber database assumes that the target control node is not enabled to register the user equipment into the IMS, responsive to no support indication being received in the request for updating a location registration of the user equipment.

3. The method according to claim 1, wherein the authorization indication is set based on if the target control node is enabled to register the user equipment into the IMS.

4. The method according to claim 3, wherein the subscriber database determines the authorization indication in addition based on at least one of the following conditions:
subscriber data related to the user equipment,
configuration data configured by a network operator of the circuit switched communication network, and
geographical area served by the target control node.

5. The method according to claim 1, the method further comprising:
sending subscriber data for the subscriber using the user equipment to the target control node, wherein the subscriber data comprise an indication whether the user equipment is to be registered into IMS by the target control node.

6. The method according to claim 1, the method further comprising:
preserving, by the source control node, the registration of the user equipment in the IMS, if the received authorization indication indicates that the user equipment is to be registered into IMS by the target control node.

7. The method according to claim 1, the method further comprising:
de-registering, by the source control node, the user equipment from the IMS, if the received authorization indication indicates that the user equipment is not to be registered into IMS by the target control node.

8. The method according to claim 7, wherein the de-registering is triggered immediately by the source control node after reception of the request for cancelling the location registration of the user equipment.

9. A method in a source control node for cancelling a location registration of a user equipment, wherein the user equipment is registered in a IP Multimedia System (IMS) and in the subscriber database while roaming from the source control node to a target control node, the source and the target control node and the subscriber database being part of a circuit switched communication network, the method comprising:
receiving a request for cancelling the location registration of the user equipment, wherein the request comprises an authorization indication indicating whether the user equipment is to be registered into IMS by the target control node; and
preserving the registration of the user equipment in the IMS, responsive to the received authorization indication indicating that the user equipment is to be registered into IMS by the target control node.

10. The method according to claim 9, the method further comprising:
de-registering the user equipment from the IMS, if the received authorization indication indicates that the user equipment is not to be registered into IMS by the target control node.

11. The method according to claim 10, wherein the de-registering is triggered immediately by the source control node at reception of the request for cancelling the location registration of the user equipment.

12. A subscriber database for cancelling a location registration of a user equipment in a source control node, wherein the user equipment is registered in a IP Multimedia System (IMS) and in the subscriber database while roaming from the source control node to a target control node, the source and the target control node and the subscriber database being part of a circuit switched communication network, the subscriber database being configured to:
receiving a request for updating a location registration of the user equipment from the target control node, wherein the request comprises a support indication indicating whether the target control node is enabled to register the user equipment into the IMS;
determining an authorization indication indicating whether the user equipment is to be registered into IMS by the target control node; and
sending a request for cancelling the location registration of the user equipment to the source control node, wherein the request comprises the authorization indication;

13. (canceled)

14. A source control node for cancelling a location registration of a user equipment wherein the user equipment is registered in a IP Multimedia System (IMS) and in the subscriber database while roaming from the source control node to a target control node, the source and the target control node and the subscriber database being part of a circuit switched communication network, the source control node being configured to:
receiving a request for cancelling the location registration of the user equipment, wherein the request comprises an authorization indication indicating whether the user equipment is to be registered into IMS by the target control node; and
preserving the registration of the user equipment in the IMS, responsive to the received authorization indication indicating that the user equipment is to be registered into IMS by the target control node.

15. (canceled)

16. A communication system for cancelling a location registration of a user equipment in a source control node, wherein the user equipment is registered in a IP Multimedia System (IMS) and in the subscriber database while roaming from the source control node to a target control node, the source and the target control node and the subscriber database being part of a circuit switched communication network, the communication system comprising:
a subscriber database configured to:
receive a request for updating a location registration of the user equipment from the target control node, wherein the request comprises a support indication indicating whether the target control node is enabled to register the user equipment into the IMS;
determine an authorization indication indicating whether the user equipment is to be registered into IMS by the target control node; and
send a request for cancelling the location registration of the user equipment to the source control node, wherein the request comprises the authorization indication; and
source control node configured to:
receive a request for cancelling the location registration of the user equipment, wherein the request comprises an authorization indication indicating whether the user equipment is to be registered into IMS by the target control node; and
preserve the registration of the user equipment in the IMS, responsive to the received authorization indication indicating that the user equipment is to be registered into IMS by the target control node.

17. (canceled)

18. A computer program product comprising a non-transitory computer readable medium storing instructions, which, when executed by at least one processor, cause the at least one processor to carry out the method of claim 1.

19. (canceled)

20. (canceled)
